(19) United States
(12) Patent Application Publication
(10) Pub. No.: US 2021/0200225 A1
(43) Pub. Date: Jul. 1, 2021

(54) SYSTEM, ON-VEHICLE DEVICE, AND INFORMATION PROCESSING DEVICE

(71) Applicant: Toyota Jidosha Kabushiki Kaisha, Toyota-shi Aichi-ken (JP)

(72) Inventor: Daiki Kaneichi, Tokyo-to (JP)

(21) Appl. No.: 17/132,495

(22) Filed: Dec. 23, 2020

(30) Foreign Application Priority Data
Dec. 25, 2019 (JP) 2019-234846

(51) Int. Cl. G05D 1/02; G01C 21/00; G06Q 30/00; G06Q 50/28; G06F 16/29; G06F 16/23; H04W 4/48; G08G 1/0969

(52) U.S. Cl. CPC G05D 1/0212; G01C 21/383; G06Q 30/018; G08G 1/0969; G06F 16/29; G06F 16/2379; H04W 4/48; G06Q 50/28

(57) ABSTRACT

A system includes: an on-vehicle device that is provided on a vehicle which autonomously travels based on map information and which is used for parcel collection and delivery; and a first information processing device that provides the on-vehicle device with first map information that is map information of an inside of a building. The first information processing device transmits, when the vehicle exists within a predetermined range from the building, the first map information to the on-vehicle device. The on-vehicle device stores the first map information received from the first information processing device, in a storage; supplies, when the vehicle autonomously travels within the building, the first map information stored in the storage to a controller comprising at least one processor that controls the autonomous traveling of the vehicle; and erases, after the vehicle leaves the building, the first map information from the storage.

### CROSS REFERENCE TO THE RELATED APPLICATION

This application claims the benefit of Japanese Patent Application No. 2019-234846, filed on Dec. 25, 2019, which is hereby incorporated by reference herein in its entirety.

### BACKGROUND

### Technical Field

The present disclosure relates to a system, an on-vehicle device, and an information processing device.

### Description of the Related Art

Japanese Patent Laid-Open No. 2013-140164 discloses a cellular telephone that displays map information. An external memory of the cellular telephone in Japanese Patent Laid-Open No. 2013-140164 stores the map information in advance. The cellular telephone acquires a current position and when map information corresponding to the current position is stored in the external memory, displays the corresponding map information.

### SUMMARY

An object of the present disclosure is to more suitably perform parcel collection and delivery at inside a building, by an autonomous traveling vehicle.

A system according to a first aspect of the present disclosure includes: an on-vehicle device that is provided on a vehicle which autonomously travels based on map information and which is used for parcel collection and delivery; and a first information processing device that provides the on-vehicle device with first map information that is map information of an inside of a building. The first information processing device transmits, when the vehicle exists within a predetermined range from the building, the first map information to the on-vehicle device. The on-vehicle device stores the first map information received from the first information processing device, in a storage; supplies, when the vehicle autonomously travels within the building, the first map information stored in the storage to a controller comprising at least one processor that controls the autonomous traveling of the vehicle; and erases, after the vehicle leaves the building, the first map information from the storage.

An on-vehicle device according to a second aspect of the present disclosure is provided on a vehicle which autonomously travels based on map information and which is used for parcel collection and delivery. The on-vehicle device includes a controller comprising at least one processor that performs: receiving, when the vehicle exists within a predetermined range from a building, first map information that is map information of an inside of the building from an information processing device which has the first map information, and storing the received first map information in a storage; supplying, when the vehicle autonomously travels within the building, the first map information stored in the storage to a controller comprising at least one processor that controls the autonomous traveling of the vehicle; and erasing, after the vehicle leaves the building, the first map information from the storage.

An information processing device according to a third aspect of the present disclosure includes a controller comprising at least one processor that transmits first map information to an on-vehicle device. The on-vehicle device is provided on a vehicle which autonomously travels based on map information and which is used for parcel collection and delivery. The on-vehicle device performs: receiving, when the vehicle exists within a predetermined range from a building, first map information that is map information of an inside of the building, and storing the received first map information in a storage; supplying, when the vehicle autonomously travels within the building, the first map information stored in the storage to a controller comprising at least one processor that controls the autonomous traveling of the vehicle; and erasing, after the vehicle leaves the building, the first map information from the storage.

The present disclosure allows more suitable parcel collection and delivery at an inside of a building to be performed by an autonomous traveling vehicle.

### BRIEF DESCRIPTION OF THE DRAWINGS

FIG. 1 illustrates a diagram of a schematic configuration of a collection and delivery system;

FIG. 2 is a block diagram schematically illustrating one example of a functional configuration of an on-vehicle device;

FIG. 3 is a block diagram schematically illustrating one example of a functional configuration of a map management server;

FIG. 4 is a diagram illustrating one example of first map information stored in a map information database;

FIG. 5 is a block diagram schematically illustrating one example of a functional configuration of a vehicle;

FIG. 6 is a flowchart of information processing in the on-vehicle device;

FIG. 7 is a flowchart of map information transmission processing according to a second embodiment;

and

FIG. 8 is a flowchart of map information transmission processing according to a third embodiment.

### DESCRIPTION OF THE EMBODIMENTS

A system according to a first aspect of the present disclosure includes an on-vehicle device provided on a vehicle and a first information processing device. Here, the vehicle is a vehicle that autonomously travels based on map information. In addition, the vehicle is used for parcel collection and delivery. Furthermore, the first information processing device is an information processing device that provides the on-vehicle device with first map information which is map information of an inside of a target building for the parcel collection and delivery by the vehicle.

In order for the vehicle to autonomously travel within the building, the first map information is necessary. Therefore, the first information processing device transmits, when the vehicle exists within a predetermined range from the building, the first map information to the on-vehicle device. That is, the on-vehicle device receives the first map information from the first information processing device immediately before the vehicle enters the building. At this time, the on-vehicle device stores the received first map information in a storage. In addition, when the vehicle autonomously travels within the building, the on-vehicle device supplies the first map information stored in the storage to a controller comprising at least one processor that controls the autonomous traveling of the vehicle. This allows the vehicle to perform parcel collection and delivery while autonomously traveling within the building. Furthermore, when parcel collection and delivery within the building is completed and the vehicle has left the building, the on-vehicle device erases the first map information of the building from the storage.

Here, when parcel collection and delivery at a plurality of buildings is performed by the vehicle, first map information of all of the plurality of buildings is required for the vehicle to autonomously travel within each of the buildings. In this case, if the first map information of all of the plurality of target buildings for parcel collection and delivery by the vehicle is stored in the storage on the on-vehicle device, the more the number of target buildings for the parcel collection and delivery is, the larger storage capacity the storage requires. In addition, map information of an inside of a building includes more detailed information as compared with outdoor map information in many cases. Therefore, an increase in the number of buildings whose first map information should be stored may require the storage to have an enormous amount of storage capacity. To avoid this, in the system according to the present disclosure, the on-vehicle device receives, when the vehicle exists within a predetermined range from a building, the first map information of the building and stores it in the storage; and erases, after the vehicle leaves the building, the first map information of the building from the storage. That is, the first map information according to the present disclosure is received by the on-vehicle device immediately before the vehicle enters a building and is erased after the vehicle leaves the building. In other words, the first map information is not always stored in the storage, but is stored in the storage for a period when the vehicle is autonomously traveling within the building. Thus, even when parcel collection and delivery at a plurality of buildings is performed by the vehicle, the storage is not required to store first map information of all of the plurality of buildings.

As described above, in the system according to the present disclosure, the vehicle can autonomously travel within a plurality of buildings without storing all of the first map information of the plurality of buildings. This allows more suitable parcel collection and delivery at an inside of a building to be performed by an autonomous traveling vehicle.

Hereinafter, specific embodiments of the present disclosure will be described with reference to drawings. The dimensions, materials, shapes, relative arrangements, and the like of the components described in the embodiments are not intended to limit a technical scope of the present disclosure thereto unless otherwise stated.

### First Embodiment

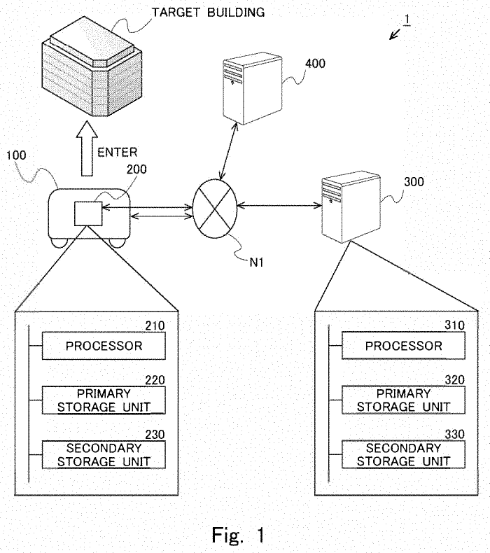

A collection and delivery system 1 according to this embodiment will be described with reference to FIG. 1. FIG. 1 is a diagram illustrating a schematic configuration of the collection and delivery system 1. The collection and delivery system 1 includes a vehicle 100, an on-vehicle device 200, a map management server 300, and a traveling management server 400. Here, the vehicle 100 is a vehicle that autonomously travels based on map information. In addition, the vehicle 100 is used for parcel collection and delivery. Furthermore, the vehicle 100 has the on-vehicle device 200 mounted thereon. In this case, when a destination of parcel collection and delivery is within a building, the vehicle 100 enters the building from outside the building where the parcel collection and delivery is to be performed (hereinafter, may be referred to as a “target building”). Then, the parcel collection and delivery is performed within the target building by the vehicle 100. Here, examples of the target building may include collective housing, a commercial facility, and other such buildings. Furthermore, after the parcel collection and delivery within the target building, the vehicle 100 leaves the target building by autonomously traveling.

In this case, in autonomously traveling within the building, the vehicle 100 autonomously travels based on map information of an inside of the building (hereinafter, may be referred to as “first map information”) which is used for autonomous traveling within the building. To do so, the on-vehicle device 200 receives, immediately before the vehicle 100 enters the target building, the first map information of the target building from the map management server 300 that provides the on-vehicle device 200 with the first map information of the target building; and stores it. Furthermore, when the vehicle 100 autonomously travels within the target building, the on-vehicle device 200 supplies the stored first map information of the target building to the vehicle 100. This allows the vehicle 100 to autonomously travel to a location where parcel collection and delivery is to be performed within the target building (hereinafter, may be referred to as a “destination”) after entering the target building, based on the first map information of the target building. Furthermore, after performing parcel collection and delivery at the destination, the vehicle 100 can leave the target building by autonomously traveling, based on the first map information of the target building. That is, the vehicle 100 can perform parcel collection and delivery while autonomously traveling within the target building. Furthermore, when the parcel collection and delivery within the target building is completed and the vehicle 100 has left the target building, the on-vehicle device 200 erases the first map information of the target building from the on-vehicle device 200. It should be noted that in this embodiment, the map management server 300 corresponds to the “first information processing device” of the present disclosure.

Here, the vehicle 100 performs collection and delivery of a plurality of parcels at a plurality of buildings as target buildings in some cases. In such cases, the vehicle 100 is required to autonomously travel within the plurality of buildings. In order for the vehicle 100 to autonomously travel within each of the buildings, first map information of all of the plurality of buildings is necessary. Here, if the on-vehicle device 200 stores the first map information of all of the plurality of target buildings for parcel collection and delivery by the vehicle 100, the more the number of target buildings for the parcel collection and delivery is, the larger storage capacity the on-vehicle device 200 requires. In addition, map information of an inside of a building includes more detailed information as compared with outdoor map information in many cases. Therefore, an increase in the number of buildings whose first map information should be stored may cause the on-vehicle device 200 to store an enormous data amount of the first map information. To avoid this situation, in this embodiment, as described above, the on-vehicle device 200 receives, immediately before the vehicle 100 enters a target building, the first map information of the target building from the map management server 300; and after the vehicle 100 leaves the target building, erases the first map information of the target building from the on-vehicle device 200. In other words, the first map information of the target building is not always stored but is stored on the on-vehicle device 200 for a period when the vehicle 100 is autonomously traveling within the target building. Thus, even when collection and delivery of a plurality of parcels at a plurality of buildings as target buildings is performed, the on-vehicle device 200 is not required to store the first map information of all of the plurality of target buildings.

In addition, in autonomously traveling outdoors, the vehicle 100 autonomously travels based on map information used for autonomously traveling outdoors (hereinafter, may be referred to as “second map information”). In this case, the vehicle 100 receives the second map information from the traveling management server 400 that provides the second map information to the vehicle 100. Thus, the vehicle 100 autonomously travels outdoors again based on the second map information after leaving the target building. As described above, the vehicle 100 autonomously travels outdoors based on the second map information and within a target building, autonomously travels based on the first map information of the target building. It should be noted that in this embodiment, the traveling management server 400 corresponds to the “second information processing device” of the present disclosure.

The on-vehicle device 200 is a device that receives the first map information from the map management server 300 and stores it. The on-vehicle device 200 includes a computer having a processor 210, a primary storage unit 220, and a secondary storage unit 230. The processor 210 is, for example, a central processing unit (CPU) or a digital signal processor (DSP). The primary storage unit 220 is, for example, a random access memory (RAM). The secondary storage unit 230 is, for example, a read only memory (ROM). In addition, the secondary storage unit 230 is, for example, a hard disk drive (HDD) or a disk recording medium such as a CD-ROM, a DVD disk, or a Blu-ray disk. Furthermore, the secondary storage unit 230 may be a removable medium (portable storage medium). Here, examples of the removal medium include a USB memory and an SD card.

On the on-vehicle device 200, the secondary storage unit 230 stores an operating system (OS), various programs, and various kinds of information tables. In addition, on the on-vehicle device 200, the processor 210 loads programs stored in the secondary storage unit 230, to the primary storage unit 220 and executes them, thereby allowing various functions described later to be implemented. However, part or all of the functions in the on-vehicle device 200 may be implemented by a hardware circuit such as ASIC or FPGA. Furthermore, the on-vehicle device 200 is not necessarily required to be implemented by a single physical configuration and may be configured by a plurality of computers that cooperate with each other.

The map management server 300 is a server that manages the first map information of a plurality of possible target buildings for parcel collection and delivery by the vehicle 100. The map management server 300 includes a computer having a processor 310, a primary storage unit 320, and a secondary storage unit 330, as with the on-vehicle device 200. In addition, the traveling management server 400 is a server that manages the second map information. The traveling management server 400 also includes a computer, as with the map management server 300.

In the collection and delivery system 1, the vehicle 100, the on-vehicle device 200, the map management server 300, and the traveling management server 400 are mutually connected by a network N1. As the network N1, for example, a wide area network (WAN) which is a global public communication network such as the Internet, or a telephone communication network such as for a cellular telephone may be adopted. The on-vehicle device 200 receives the first map information from the map management server 300 via the network N1. In addition, the vehicle 100 receives the second map information from the traveling management server 400 via the network N1.

(System Configuration)

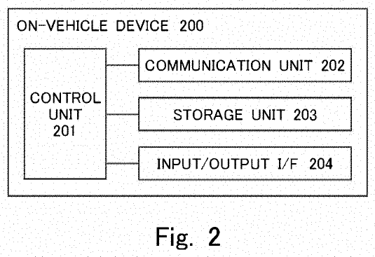

Next, description will be made with reference to FIG. 2 to FIG. 5, as to each of functional configurations of the on-vehicle device 200, the map management server 300, the vehicle 100, and the traveling management server 400 which constitute the collection and delivery system 1 according to this embodiment.

(On-Vehicle Device)

FIG. 2 is a block diagram schematically illustrating one example of a functional configuration of the on-vehicle device 200. The on-vehicle device 200 includes a control unit 201, a communication unit 202, a storage unit 203, and an input/output interface 204.

The communication unit 202 is a communication device for connecting the on-vehicle device 200 to the network N1. The communication unit 202 includes a wireless communication circuit for wireless communication. The communication unit 202 allows the on-vehicle device 200 to communicate with the map management server 300. In addition, the storage unit 203 is a device that stores the first map information. The storage unit 203 can be implemented by the secondary storage unit 230.

The input/output interface (hereinafter, may be referred to as an “input/output I/F”) 204 is an interface for transmitting and receiving various kinds of data between the on-vehicle device 200 and the vehicle 100. Examples of the input/output I/F 204 include a universal serial bus (USB) interface and a Bluetooth (registered trademark) interface.

The control unit 201 acquires, from the vehicle 100, both a current position of the vehicle 100 traveling outdoors and building information including positional information of a target building. The control unit 201 can specify a location of the target building from the building information. Thus, when the current position of the vehicle 100 is within a predetermined range from the target building, the control unit 201 transmits, to the map management server 300 via the communication unit 202, a request notification for requesting the map management server 300 to transmit the first map information of the target building. Here, the predetermined range is set so that the vehicle 100 traveling outdoors can receive the first map information before arriving at the target building. In addition, in a case where the vehicle 100 performs collection and delivery of a plurality of parcels at a plurality of buildings as target buildings, the predetermined range is a range between a building which the vehicle 100 has left after performing the parcel collection and delivery and a target building toward which the vehicle 100 is traveling for the next parcel collection and delivery. That is, in this case, the meaning that the vehicle 100 exists within a predetermined range from a target building is that the vehicle 100 exists between the target building and a last building where parcel collection and delivery has been performed. In addition, the building information is associated with a building ID for specifying a building and the building ID of a target building is added to the request notification. This allows the map management server 300 to grasp the building (target building) the transmission of whose first map information is requested by the control unit 201. Thus, the on-vehicle device 200 transmits the request notification when the vehicle 100 exists within a predetermined range from a target building and thereby can receive the first map information of the target building from the map management server 300 immediately before the vehicle 100 enters the target building.

In addition, when the first map information is received from the map management server 300 via the communication unit 202, the control unit 201 stores the first map information in the storage unit 203. Furthermore, the control unit 201 receives a supply request notification for requesting the on-vehicle device 200 to supply the first map information, from the vehicle 100 via the input/output I/F 204. Then, the control unit 201 which has received the supply request notification supplies the first map information to the vehicle 100 via the input/output I/F 204 when the vehicle 100 travels within the target building. Furthermore, the control unit 201 determines whether the vehicle 100 has left the target building, based on the current position of the vehicle 100. When the vehicle 100 has left the target building, the first map information of the target building becomes unnecessary. Therefore, when it is determined that the vehicle 100 has left the target building, the control unit 201 erases the first map information from the storage unit 203.

(Map Management Server 300)

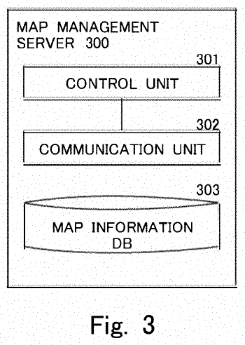

FIG. 3 is a block diagram schematically illustrating one example of a functional configuration of the map management server 300. The map management server 300 includes a control unit 301, a communication unit 302, and a map information database 303. The communication unit 302 is a communication device for connecting the map management server 300 to the network N1. The communication unit 302 includes a local area network (LAN) interface board or a wireless communication circuit for wireless communication.

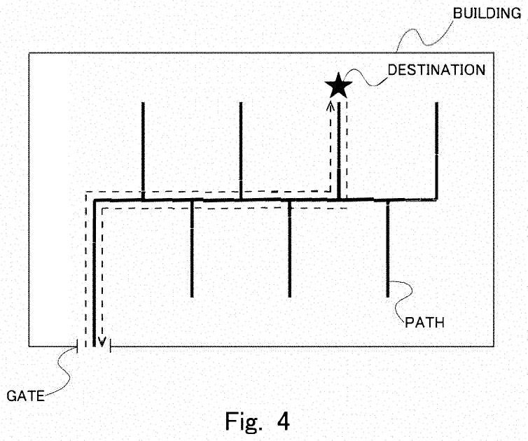

The map information database (hereinafter, may be referred to as a “map information DB”) 303 is a database for storing the first map information. The map information DB 303 can be implemented by the secondary storage unit 330. In the map information DB 303, a building ID and the first map information of a building corresponding to the building ID are stored in association with each other. FIG. 4 is a diagram illustrating one example of the first map information stored in the map information database 303. In the first map information, paths on which the vehicle 100 can travel are illustrated as indicated by a bold line in FIG. 4. In addition, the first map information may include information on ways to move between floors within the building. Examples of the information on ways to move between floors within the building include information on: a position of an elevator, escalator, slope, or the like; and floors between which move is allowed by such ways to move between floors within the building. This allows the vehicle 100 which has acquired the first map information to grasp a path for moving between floors within the building.

The control unit 301 has a function of performing arithmetic processing for controlling the map management server 300. The control unit 301 can be implemented by the processor 310. The control unit 301 receives a request notification from the on-vehicle device 200 via the communication unit 302. When the request notification is received from the on-vehicle device 200, the control unit 301 transmits the first map information of a building corresponding to a building ID which is added to the request notification, to the on-vehicle device 200 via the communication unit 302.

(Vehicle)

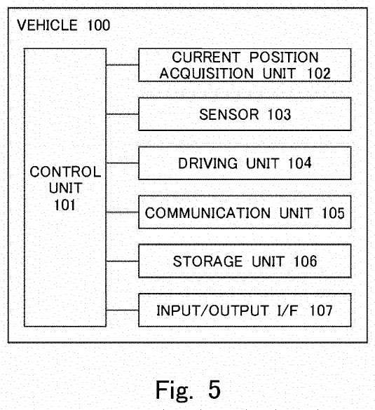

FIG. 5 is a block diagram schematically illustrating one example of a functional configuration of the vehicle 100. The vehicle 100 includes a control unit 101, a current position acquisition unit 102, a sensor 103, a driving unit 104, a communication unit 105, a storage unit 106, and an input/output I/F 107. The input/output I/F 107 is an interface similar to the input/output I/F 204 in the on-vehicle device 200 and therefore, description thereof will be omitted.

The current position acquisition unit 102 is a device that acquires a current position of the vehicle 100. The current position acquisition unit 102 acquires the current position of the vehicle 100 by a publicly known method such as GPS positioning, Wi-Fi (registered trademark) positioning, or beacon positioning.

The sensor 103 is a device for sensing surrounding situations of the vehicle 100. Specifically, the sensor 103 includes a stereo camera, a laser scanner, a LIDAR, or a radar.

The driving unit 104 includes a motor as a prime mover and mechanisms for making the vehicle 100 travel (for example, inverter, brake, tire, and steering mechanisms). The driving unit 104 makes the vehicle 100 travel based on control information which is transmitted from the control unit 101. Here, the control information includes: information for controlling a rotation speed of the motor; information for controlling a braking force of a brake; and information for controlling a steering angle.

The communication unit 105 is a communication device for connecting the vehicle 100 to the network N1. The communication unit 105 includes a wireless communication circuit for wireless communication. The communication unit 105 allows the vehicle 100 to communicate with the traveling management server 400. The storage unit 106 stores the second map information. The storage unit 106 can be implemented by a secondary storage unit provided in the vehicle 100. In addition, in the storage unit 106, a building ID, building information of a building corresponding to the building ID, and destination information of the building corresponding to the building ID are stored in association with one another. Here, the destination information is information including an ID or coordinates, or the like for specifying a destination within the building. When the vehicle 100 performs collection and delivery of a plurality of parcels at a plurality of buildings as target buildings, a building ID, building information, and destination information of each of the buildings are stored.

The control unit 101 has a function of performing arithmetic processing for controlling autonomous traveling of the vehicle 100. The control unit 101 can be implemented by a processor provided in the vehicle 100. The control unit 101 detects a surrounding environment of the vehicle 100, based on information acquired by the sensor 103. For example, the control unit 101 detects objects such as other vehicles (including people and animals) that exist in surroundings of the vehicle 100. In addition, the control unit 101 detects such various targets required for autonomous traveling of the vehicle 100, as a number and positions of lanes on a road, a structure of the road, traffic signs, and the like. Furthermore, the control unit 101 may track the detected objects. In this case, the control unit 101 may, for example, determine the relative velocity of the object from a difference between coordinates of the object detected one step before and current coordinates of the object.

In addition, when the vehicle 100 travels outdoors, the control unit 101 acquires the second map information and the building information from the storage unit 106. Then, the control unit 101 generates a path to a target building, based on current position information, the second map information, and the building information. Furthermore, the control unit 101 generates control information for controlling autonomous traveling of the vehicle 100, based on the path to the target building, the current position of the vehicle 100, and surrounding environment data detected by the sensor 103. When an object with which the vehicle 100 is likely to collide is detected by the sensor 103, the control unit 101 executes a collision avoidance control for making the vehicle 100 travel so as to avoid collision with the object. It should be noted that as a method for making the vehicle 100 autonomously travel as described above, a publicly known method can be adopted.

In addition, when the vehicle 100 enters the target building, the control unit 101 transmits a supply request notification to the on-vehicle device 200 via the input/output I/F 107. Then, the control unit 101 acquires the first map information stored in the storage unit 203 in the on-vehicle device 200, via the input/output I/F 107. After that, the control unit 101 generates a path to a destination from entering of the vehicle 100 into the target building for parcel collection and delivery at the destination, based on the current position information, the first map information, and the destination information. Furthermore, the control unit 101 also generates a path for leaving the target building from the destination in order to leave the target building after parcel collection and delivery at the destination. In the example illustrated in FIG. 4, a scheduled traveling path which is a path from the vehicle 100 entering into the target building to leaving the target building, as indicated by a broken line with arrows, is generated by the control unit 101. Then, the control unit 101 generates control information for controlling the driving unit 104 in the vehicle 100. It should be noted that since a method by which the control unit 101 controls the autonomous traveling of the vehicle 100 based on the first map information is similar to a method by which the control unit 101 controls the autonomous traveling of the vehicle 100 based on the second map information, description thereof will be omitted. Thus, the control unit 101 controls the autonomous traveling of the vehicle 100 outdoors based on the second map information and controls the autonomous traveling of the vehicle 100 within the target building based on the first map information.

(Information Processing in On-Vehicle Device)

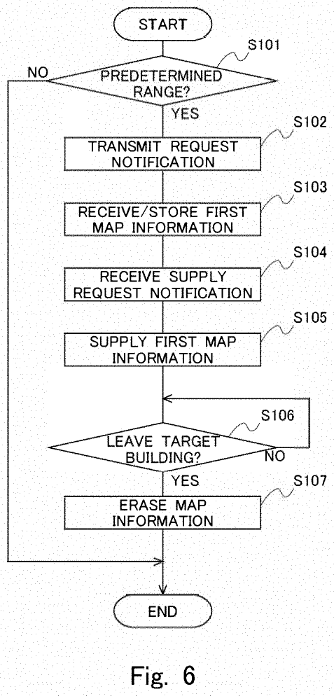

Next, information processing in the on-vehicle device 200 will be described with reference to FIG. 6. FIG. 6 is a flowchart of information processing in the on-vehicle device 200. In the information processing in the on-vehicle device 200, the on-vehicle device 200 receives the first map information of a target building in order for the vehicle 100 to autonomously travel within the target building; and erases it. The information processing in the on-vehicle device 200 is executed by the control unit 201 in the on-vehicle device 200.

In the information processing in the on-vehicle device 200, it is first determined at S101 whether the vehicle 100 exists within a predetermined range from a target building. Here, when the vehicle 100 performs parcel collection and delivery at a plurality of buildings, it is determined whether the vehicle 100 exists within a predetermined range from a target building toward which it is traveling. If a negative determination is made at S101, the information processing in the on-vehicle device 200 ends. In addition, if an affirmative determination is made at S101, a request notification including a building ID of the target building is transmitted to the map management server 300 at S102. Next, at S103, the first map information of the target building is received from the map management server 300 and the first map information is stored in the storage unit 203. Next, when the vehicle 100 enters the target building, a supply request notification is received from the vehicle 100 at S104. Next, at step S105, the first map information is supplied to the vehicle 100. That is, at S105, the first map information is acquired by the vehicle 100 that enters the target building; and the vehicle 100 autonomously travels within the target building. Then, at S106, whether the vehicle 100 has left the target building is determined. If a negative determination is made at S106, the determination at S106 is performed again. In addition, if an affirmative determination is made at S106, the first map information of the target building which the vehicle 100 has left is erased from the storage unit 203 at S107.

As described above, the on-vehicle device 200 receives the first map information of the target building from the map management server 300 immediately before entry into the target building. In addition, when the vehicle 100 autonomously travels within the target building, the on-vehicle device 200 supplies the first map information to the control unit 101 in the vehicle 100. Furthermore, after the vehicle 100 has left the target building, the on-vehicle device 200 erases the first map information from the storage unit 203. This allows the vehicle 100 to perform collection and delivery of a plurality of parcels at a plurality of buildings even when the on-vehicle device 200 does not store the first map information of all of the plurality of target buildings. Thus, parcel collection and delivery at a destination within a target building can be more suitably performed by the vehicle 100 that autonomously travels.

When a situation inside the building changes, the first map information stored in the map information DB 303 may be updated. Examples of a change in the situation inside the building include new arrangement of an object that may be an obstacle against traveling of the vehicle 100. One thereof is that an article display rack or the like that may be an obstacle against traveling of the vehicle 100 is newly arranged within a commercial facility building. Thus, when a situation inside the building changes, the first map information is updated. The update of the first map information may be performed by a manager who manages the building. In addition, the update of the first map information may be performed by the map management server 300, based on a change in the situation inside the building which is acquired by a camera, sensor, or the like provided within the building. The first map information is thus updated, so that the vehicle 100 can autonomously travel within the building based on new map information.

In addition, the map management server 300 may obtain a congestion situation inside the building and transmit information on the acquired congestion situation inside the building to the on-vehicle device 200 together with the first map information. Here, the congestion situation inside the building is, for example, a situation of congestion inside the building due to people, vehicles, or the like. The congestion situation inside the building is, for example, acquired by a camera, sensor, or the like inside the building. In addition, the congestion situation inside the building may be acquired by a building manager's input of the congestion situation inside the building to the map management server 300. The on-vehicle device 200 stores information on the congestion situation inside the building in the storage unit 203 together with the first map information. In addition, the on-vehicle device 200 transmits the information on the congestion situation inside the building to the control unit 101 in the vehicle 100 together with the first map information. Then, the control unit 101 generates a scheduled traveling path based on the first map information and the information on the congestion situation inside the building. For example, the vehicle 100 generates a scheduled traveling path so as to avoid a congested path. Thus, the vehicle 100 can generate a scheduled traveling path according to a congestion situation inside the building.

In addition, the map management server 300 that manages the first map information and the traveling management server 400 may be a single server. That is, the transmission of the first map information and the transmission of the second map information may be performed by a single server. Furthermore, in this embodiment, the map management server 300 is a server that manages the first map information of a plurality of target buildings for parcel collection and delivery by the vehicle 100; and one unit of the map management server 300 is included in the collection and delivery system 1. However, a plurality of the map management servers 300 may be included in the collection and delivery system 1. In this case, each of the map management servers 300 may manage the first map information of one target building for parcel collection and delivery by the vehicle 100.

(Modification)

In the above-mentioned embodiment, the on-vehicle device 200 that receives and stores the first map information is mounted on the vehicle 100. However, the on-vehicle device 200 may be a component of the vehicle 100. That is, the vehicle 100 and the on-vehicle device 200 may constitute a single device and the vehicle 100 may have functions of the on-vehicle device 200. In this case, functions performed by the control unit 201, the communication unit 202, and the storage unit 203 in the on-vehicle device 200 are implemented by the control unit 101, the communication unit 105, and the storage unit 106 in the vehicle 100, respectively. That is, when the vehicle 100 travels within the target building, not only the second map information but also the first map information is stored in the storage unit 106 of the vehicle 100.

### Second Embodiment

In a second embodiment, the map management server 300 that has received a request notification determines whether the vehicle 100 is a vehicle permitted to enter a building. The following describes only points different from the first embodiment.

The on-vehicle device 200 in this embodiment adds both a vehicle ID for specifying the vehicle 100 on which the on-vehicle device 200 is provided and a building ID to a request notification and transmits the notification. In addition, in the map information DB 303 of the map management server 300, a building ID, the first map information of a building corresponding to the building ID, and a vehicle ID of a vehicle permitted to enter the building corresponding to the building ID are stored in association with one another. Therefore, the map management server 300 can determine whether the vehicle ID added to the request notification which has been transmitted by the vehicle 100 is a vehicle ID for which entry to a building corresponding to a building ID added to the request notification is permitted. This allows the map management server 300 to determine whether the vehicle 100 is a vehicle permitted to enter the building. It should be noted that the vehicle ID in this embodiment corresponds to the “identifier for specifying a vehicle” of the present disclosure.

(Map Information Transmission Processing)

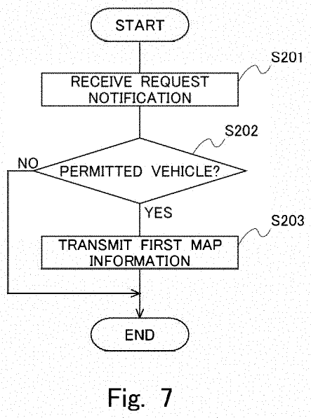

Map information transmission processing executed by the control unit 301 in the map management server 300 in the collection and delivery system 1 will be described with reference to FIG. 7. The map information transmission processing is processing for the map management server 300 to transmit the first map information to the on-vehicle device 200. FIG. 7 is a flowchart of the map information transmission processing according to this embodiment.

In the map information transmission processing, a request notification is received from the on-vehicle device 200 first at S201. Next, at S202, it is determined whether the vehicle 100 is permitted to enter a building, based on a vehicle ID added to the request notification. If an affirmative determination is made at S202, the first map information is transmitted to the on-vehicle device 200 at S203. If a negative determination is made at S202, the map information transmission processing ends. That is, the first map information is not transmitted to the on-vehicle device 200.

Thus, the map management server 300 determines whether the vehicle 100 which has transmitted the request notification is a vehicle permitted to enter the building, thereby allowing a vehicle not permitted to enter the building to be prevented from entering the building. In addition, it can also be prevented that the first map information of a building is transmitted to a vehicle not permitted to enter the building or an on-vehicle device provided on the vehicle. Thus, the control unit 301 determines whether the vehicle 100 is permitted to enter the building, thereby allowing security inside the building to be enhanced.

In this embodiment, the map management server 300 determines whether the vehicle 100 is a vehicle permitted to enter the building, based on the vehicle ID of the vehicle 100. However, a method for the map management server 300 determining whether the vehicle 100 is a vehicle permitted to enter the building is not limited to the one based on the vehicle ID. For example, the map management server 300 acquires a collection and delivery schedule of the vehicle 100 from a server that manages parcel collection and delivery, or the like; and stores it in a database for managing the collection and delivery schedule. Here, the database for managing the collection and delivery schedule can be implemented by the secondary storage unit 330. The map management server 300 determines whether the vehicle 100 is a vehicle permitted to enter the building, based on the collection and delivery schedule of the vehicle 100 which is stored in the database for managing the collection and delivery schedule. Here, the collection and delivery schedule of the vehicle 100 includes, for example, information in which the building ID of a target building of the vehicle 100 and information on a time or date of parcel collection and delivery in the target building are associated with each other. The map management server 300 determines whether a building ID added to a request notification and a time or date when the request notification is received match the building ID and the time or date of parcel collection and delivery in the parcel collection and delivery schedule. If the map management server 300 makes an affirmative determination, the map management server 300 determines that the vehicle 100 is a vehicle permitted to enter the building. If the map management server 300 makes a negative determination, the map management server 300 determines that the vehicle 100 is a vehicle not permitted to enter the building. Thus, security inside the building can also be enhanced.

### Third Embodiment

Next, a collection and delivery system according to a third embodiment will be described. The following describes only points different from the first embodiment.

The map management server 300 according to this embodiment transmits, when a request notification is received from the on-vehicle device 200, confirmation information for confirming whether to permit parcel collection and delivery, to a user terminal of a parcel collection and delivery target user. Here, the user terminal of the user is, for example, a computer or smartphone that the user uses. When permission information indicating that parcel collection and delivery is permitted from the user terminal is received, the map management server 300 transmits the first map information to the on-vehicle device 200. This allows a vehicle not permitted to perform parcel collection and delivery by a user to be prevented from entering a building. In addition, this also allows a vehicle not permitted to perform parcel collection and delivery by the user to be prevented from obtaining the first map information. Thus, whether to permit parcel collection and delivery is confirmed by the user, thereby allowing security inside the building to be enhanced.

(Map Information Transmission Processing)

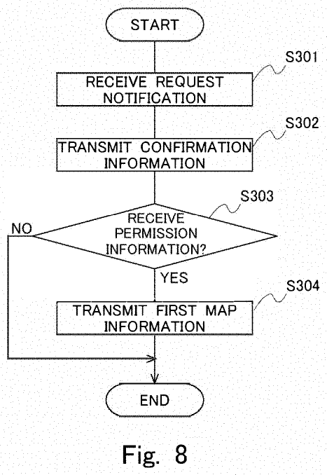

Next, map information transmission processing executed by the control unit 301 in the map management server 300 in the collection and delivery system 1 according to this embodiment will be described with reference to FIG. 8. FIG. 8 is a flowchart of the map information transmission processing according to this embodiment. In addition, processing procedures at S301 and S304 indicated in FIG. 8 are similar to processing procedures at step 201 and S203 indicated in FIG. 7, respectively; and therefore, their descriptions will be omitted. In the map information transmission processing, confirmation information is transmitted to the user terminal at step 302. Then, at S303, it is determined whether permission information is received. If an affirmative determination is made at S303, the first map information is transmitted at S304. If a negative determination is made at S303, the map information transmission processing ends.

### Other Embodiments

The above embodiments are merely one example, and the present disclosure can be appropriately modified and implemented without departing from the spirit thereof. In addition, the processing and techniques described in the present disclosure can be implemented in combination as long as a technical contradiction does not occur.

In addition, the processing described as being performed by one device may be shared and executed by a plurality of devices. Alternatively, the processing described as being performed by different devices may be executed by one device. In the computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer readable storage media include: any type of disk such as a magnetic disk (floppy (registered trademark) disk, hard disk drive (HDD), etc.), an optical disk (CD-ROM, DVD disk, Blu-ray disk, etc.); any type of medium suitable for storing electronic instructions, such as read-only memory (ROM), random access memory (RAM), EPROM, EEPROM, magnetic cards, flash memory, and optical cards.

### DESCRIPTION OF THE REFERENCE NUMERALS AND SYMBOLS

1 collection and delivery system
100 vehicle
200 on-vehicle device
201 control unit
203 storage unit
300 map management server
301 control unit
303 map information database
400 traveling management server

What is claimed is:

1. A system, comprising:
an on-vehicle device that is provided on a vehicle, the vehicle autonomously traveling based on map information and being used for parcel collection and delivery; and
a first information processing device that provides first map information to the on-vehicle device, the first map information being map information of an inside of a building; wherein
the first information processing device transmits, when the vehicle exists within a predetermined range from the building, the first map information to the on-vehicle device; and
the on-vehicle device stores the first map information received from the first information processing device, in a storage; supplies, when the vehicle autonomously travels within the building, a controller comprising at least one processor with the first map information stored in the storage, the controller controlling autonomous traveling of the vehicle; and erases, after the vehicle leaves the building, the first map information from the storage.

2. The system according to claim 1, wherein
the on-vehicle device transmits, when the vehicle exists within a predetermined range from the building, a request notification to the first information processing device, the request notification requesting transmission of the first map information.

3. The system according to claim 2, wherein
the first information processing device determines, upon receipt of the request notification, whether the vehicle is a vehicle permitted to enter the building; and transmits, when it is determined that the vehicle is a vehicle permitted to enter the building, the first map information to the on-vehicle device.

4. The system according to claim 3, wherein
the first information processing device receives an identifier from the on-vehicle device, the identifier specifying the vehicle; and determines whether the vehicle is a vehicle permitted to enter the building, based on the identifier.

5. The system according to claim 3, wherein
the first information processing device acquires a collection and delivery schedule for parcel collection and delivery by the vehicle; and determines whether the vehicle is a vehicle permitted to enter the building, based on the acquired collection and delivery schedule.

6. The system according to claim 2, wherein
the first information processing device transmits, upon receipt of the request notification, confirmation information to a user terminal of a target user of the parcel collection and delivery, the confirmation information being for confirming whether to permit the parcel collection and delivery; and transmits, when permission information is received from the user terminal, the first map information to the on-vehicle device, the permission information indicating that the parcel collection and delivery is permitted.

7. The system according to claim 1, wherein
the first information processing device has a database for storing the first map information; and the first map information stored in the database is updated when a situation inside the building is changed.

8. The system according to claim 1, wherein
the first information processing device acquires a congestion situation inside the building and transmits information on the acquired congestion situation inside the building to the on-vehicle device together with the first map information; and
the on-vehicle device stores the information on the congestion situation inside the building in the storage together with the first map information, and supplies the controller with the information on the congestion situation inside the building together with the first map information, the information on the congestion situation inside the building being stored in the storage.

9. The system according to claim 1, wherein
the first map information includes information on ways to move between floors within the building.

10. The system according to claim 1, further comprising
a second information processing device different from the first information processing device, the second information processing device transmitting second map information to the vehicle, the second map information being map information for the vehicle autonomously traveling outdoors.

11. The system according to claim 1, wherein
the on-vehicle device is a component of the vehicle.

12. An on-vehicle device that is provided on a vehicle, the vehicle autonomously traveling based on map information and being used for parcel collection and delivery, wherein
the on-vehicle device comprises a controller comprising at least one processor configured to perform:
receiving, when the vehicle exists within a predetermined range from a building, first map information from an information processing device that has the first map information, and storing the received first map information in a storage, the first map information being map information of an inside of the building;
supplying, when the vehicle autonomously travels within the building, the first map information stored in the storage to a controller comprising at least one processor that controls autonomous traveling of the vehicle; and
erasing, after the vehicle leaves the building, the first map information from the storage.

13. An information processing device, comprising:
a controller comprising at least one processor configured to execute transmission of first map information to an on-vehicle device, wherein;
the on-vehicle device is provided on a vehicle, the vehicle autonomously traveling based on map information and being used for parcel collection and delivery; and
the on-vehicle device performs:
receiving, when the vehicle exists within a predetermined range from a building, first map information that is map information of an inside of the building, and storing the received first map information in a storage;
supplying, when the vehicle autonomously travels within the building, the first map information stored in the storage to a controller comprising at least one processor that controls autonomous traveling of the vehicle; and
erasing, after the vehicle leaves the building, the first map information from the storage.

14. The information processing device according to claim 13, wherein
the controller performs:
receiving a request notification from the on-vehicle device, the request notification requesting transmission of the first map information.

15. The information processing device according to claim 14, wherein
the controller performs:
further determining, upon receipt of the request notification, whether the vehicle is a vehicle permitted to enter the building; and
transmitting, when it is determined that the vehicle is a vehicle permitted to enter the building, the first map information to the on-vehicle device.

16. The information processing device according to claim 15, wherein
the controller performs:
receiving an identifier from the on-vehicle device, the identifier specifying the vehicle; and
determining, based on the identifier, whether the vehicle is a vehicle permitted to enter the building.

17. The information processing device according to claim 15, wherein
the controller performs:
obtaining a collection and delivery schedule for parcel collection and delivery by the vehicle; and
determining, based on the acquired collection and delivery schedule, whether the vehicle is a vehicle permitted to enter the building.

18. The information processing device according to claim 14, wherein
the controller performs:
transmitting, upon receipt of the request notification, confirmation information to a user terminal of a target user of the parcel collection and delivery, the confirmation information being for confirming whether to permit the parcel collection and delivery; and
transmitting, when permission information is received from the user terminal, the first map information to the on-vehicle device, the permission information indicating that the parcel collection and delivery is permitted.

19. The information processing device according to claim 13, comprising:
a database for storing the first map information; wherein
the controller updates, when a situation inside the building is changed, the first map information stored in the database.

20. The information processing device according to claim 13, wherein
the controller acquires a congestion situation inside the building and transmits information on the acquired congestion situation inside the building to the on-vehicle device together with the first map information.
